(19) United States
(12) Patent Application Publication
(10) Pub. No.: US 2005/0226005 A1
(43) Pub. Date: Oct. 13, 2005

(54) Backlight module and fixing mechanism therein

(75) Inventor: Hsiao-Te Yang, Hsinchu City (TW)

Correspondence Address: BRUCE H. TROXELL, SUITE 1404, 5205 LEESBURG PIKE, FALLS CHURCH, VA, 22041, US

(73) Assignee: AU Optronics Corp.

(21) Appl. No.: 11/061,810

(22) Filed: Feb. 22, 2005

(30) Foreign Application Priority Data
Apr. 13, 2004 (TW) 93110238

(51) Int. Cl. F21V 8/00; F21V 17/00

(52) U.S. Cl. 362/634; 362/633

(57) ABSTRACT

A fixing mechanism of a backlight module is capable of fixing a light-guide plate in a frame. The fixing mechanism comprises a rib and a trough. The rib is disposed on a bottom-surface of the light-guide plate, and the trough, corresponding the rib, is disposed on the frame. When the light-guide plate combines with the frame, the rib is disposed in the trough. With the combination of the trough and the rib, the interactive sliding between the light-guide plate and the frame is avoided. Hence, a solid and stable backlight module is provided.

### BACKGROUND OF THE INVENTION

(1) Field of the Invention

The present invention relates to a backlight module. More particularly, the present invention relates to a fixing mechanism of the backlight module.

(2) Description of the Prior Art

Please refer to FIG. 1; FIG. 1 is a cross section view of a conventional LCD (liquid crystal display). The LCD 10 comprises an panel 12 and a backlight module 20.

Within, the panel 12 is a non-irradiation display device that needs a light-guide plate 20 to provide light 14 so as to present images. The panel 12 comprises a TFT (thin film transistor) array, a liquid crystal layer and a color filter. The TFT array controls tilt angels of the liquid crystal molecules so as to modulate the brightness of the light 14 from the backlight module 20. The color filter determines what particular colors should be given out through the panel 12.

In general, the present invention is concerning to the uniformity of the light 14, which is provide by the back light module 20, and the assembly quality of the backlight module 20.

The conventional backlight module 20 shown in FIG. 1 comprises a light-guide plate 22, a lamp 24, a lamp-reflector 26, and a frame 28.

The light-guide plate 22, which is disposed on the frame 28, comprises a back-end 221, a front-end 223, an upper-surface 222, and a bottom-surface 224. The bottom-surface 224 is designed to have a protrusion pattern, which spread light 14 more evenly from the light-guide plate 22. A plurality of optical films is disposed on the upper-surface 222 of the light-guide plate 22 to enhance brightness or to output the light 14 evenly.

The lamp 24 is disposed at the back-end 221. Mostly and generally, the lamp 24 used in the backlight module as light source is either a cold cathode fluorescent lamp (CCFL) or light emitting diodes (LEDs). The back light module 20 configured as shown in FIG. 1 is often called “an edge light type”.

The lamp-reflector 26 disposed outside the lamp 24 is usually designed in a C-shape structure for shielding and reflecting purpose. The reflectivity of the lamp-reflector 26 can converge the light generated from the lamp 24 at the back-end 221. The C-shape lamp-reflector 26 as shown can mount thereinside the lamp 24 and the back-end 221 of the light-guide plate 22 nicely and tightly.

The lamp-reflector 26 and the back-bezel 28 can be fixed by proper joining means such as a screw-and-hole pair, or an anchoring bolt-and-slot pair. With the help of the lamp-reflector 26, the light-guide plate 22 inside the back-bezel 28 can be fixed at the back-end 221.

Referring to FIG. 2, an explosion diagram of a backlight module of Prior Art I is shown. It is well known in the art that, before shipping, the LCD 10 must go through a series of strict impact tests. To pass the impact tests, the LCD 10 has a side-protrusion structure 225 on both sides of the light-guide plate 22 for pairing respective ditches 285 at the back-bezel 28. As shown in FIG. 2, the match of the side-protrusion structure 225 and the ditch 285 can be easily seen.

Possible light scattering occurs at the portion of the LCD 10 near side-protrusion structure 225. Such a phenomenon is known as the “light leakage”, which would cause an uneven distribution of brightness and damage the image quality of the LCD 10.

While a major object of developing skills associated with LCD 10 is the display quality, the fault of the Prior Art I described above becomes not tolerable. For overcoming the fault, recently, there are more and more light-guide plates 32 that without protruding structure (shown in FIG. 3) being used in LCD 10.

In order to improve the problem of the aforesaid light leakages in Prior Art I, more and more LCD choose to remove the side-protrusion structures 225 on the light-guide plates. Referring to FIG. 3, an explosion diagram of a back light module of Prior Art II is shown. Since most of the devices within Prior Art II are similar to those in Prior Art I, only different devices shall be discussed in the following paragraphs. Also refer to FIG. 4; FIG. 4 is a cross section view of the backlight module shown in FIG. 3.

Major difference between the Prior Art I and the Prior Art II is that the light-guide plate 32 of the Prior Art II does not have the side-protrusion structure as mentioned in the Prior Art I. In addition, as shown in FIG. 3, no ditch inside the back-bezel 38 is shown. In order to increase the stability of light-guide plate 32, an adhesive tape 45 to substitute the side-protrusion structure 225 and the ditch 285 in FIG. 2 is applied between the front end 323 of the light-guide plate 32 and the back bezel 40.

Considering the disadvantage of light-leakage or uneven-brightness of Prior Art I, the light-guide plate 32 of Prior Art II that without the side-protrusion structure is applied of vast majority. However, this is a kind of trade between display quality and steady assembly (of LCD 10).

In the backlight module 30 (Prior Art II), the light-guide plate 32 is mounted in the frame 38 by the C-shape lamp-reflector 36 and the adhesives 45. In some strict impact tests, the light-guide plate 32 usually hits the lamp 34. The lamp 34 or the light-guide plate 32 is broken frequently.

Furthermore, when the LCD 10 product is being operated, the backlight module 32 generally stands as shown in FIG. 4. Hence, the weight of the light-guide plate 32 are sustained by the adhering-force of the adhesives 45 and by the clamping-force of the lamp-reflector 36. Besides, the LCD 10 in function generates heats so that the adhesive tape 45 often lies in high temperature environments, which cause the viscosity of the adhesive tape 45 go bad gradually. These show that there are still several defects among the conventional LCD 10.

Hence, to the researchers who engage in the related LCD region, they are hard trying to improve the fault of prior arts to further promoting the quality of LCD, especially, the light uniformity and the assembly quality of the backlight module within.

### SUMMARY OF THE INVENTION

Accordingly, one major object of the present invention is to provide a solid and stable backlight module.

Another object of the present invention is to provide a backlight module that can present a better quality in preventing from accidental crashes.

In addition, it is a further object of the present invention to provide a fixing mechanism of a backlight module, with which, even under strong impacts, the light-guide plate would not hit on the lamp to cause any further interior damage.

A backlight module for providing a backlight source to a display, such as LCD, is provided. The backlight module at least comprises a frame, a light-guide plate, a lamp and a lamp reflector. A fixing mechanism of the present invention is capable of fixing the light-guide plate in the frame. The fixing mechanism comprises a rib and a trough. The rib is disposed on a bottom-surface of the light-guide plate, and the trough, corresponding the rib, is disposed on the frame. When the light-guide plate combines with the frame, the rib is disposed in the trough. With the combination of the trough and the rib, the interactive sliding between the light-guide plate and the frame is avoided. Hence, a solid and stable backlight module is provided.

The backlight module of the present invention achieves following advantages: 1) prevent light leakages on the display; and 2) intensify the anti-vibration ability to enhance the overall stability of the backlight module; so that even under strong crashes or vibrations, the light-guide plate would not strike on lamp to cause any further damage inside.

### BRIEF DESCRIPTION OF THE DRAWINGS

FIG. 1 is a cross section view of a conventional LCD;

FIG. 2 is an explosion diagram of a backlight module of Prior Art I;

FIG. 3 is an explosion diagram of a backlight module of Prior Art II;

FIG. 4 is a cross section view of the backlight module of FIG. 3;

FIG. 5 is an explosion diagram of the backlight module of the present invention; and

FIG. 6 shows a cross-section view of the backlight module of FIG. 5.

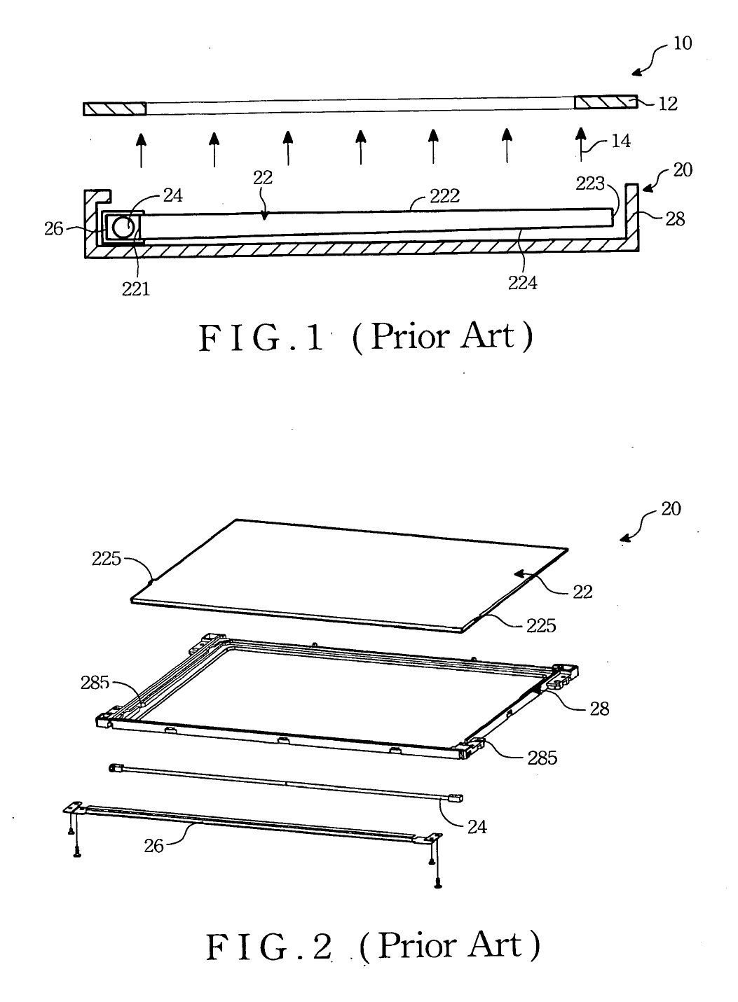

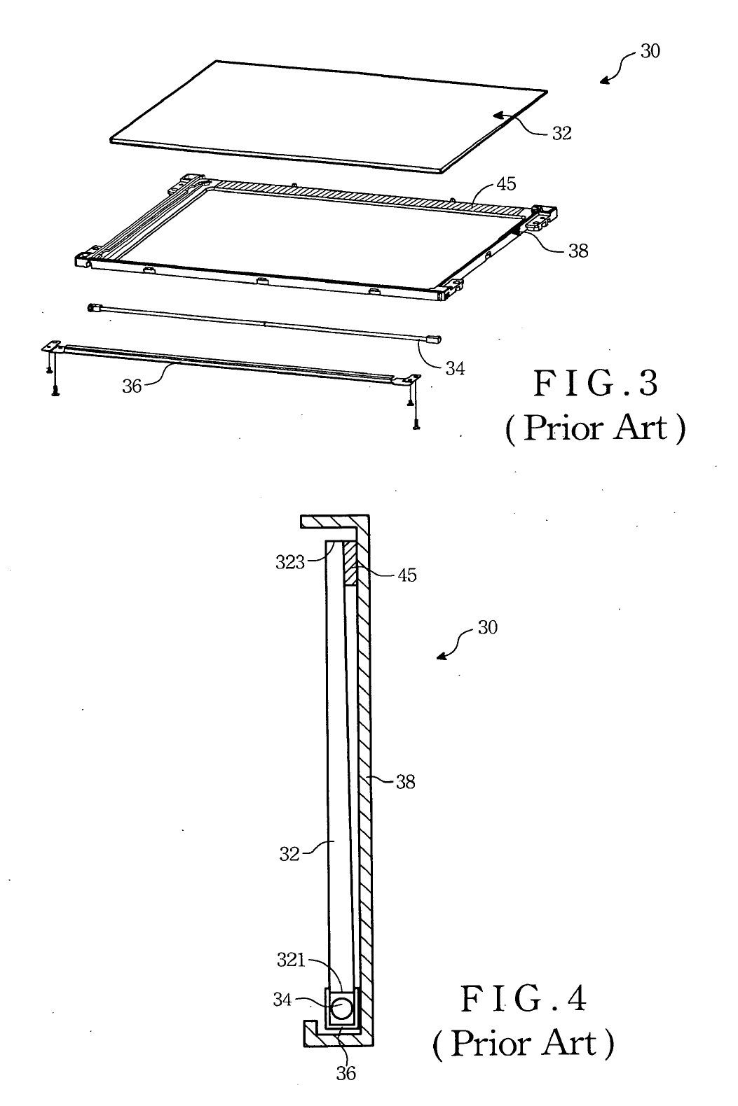

### DESCRIPTION OF THE PREFERRED EMBODIMENT

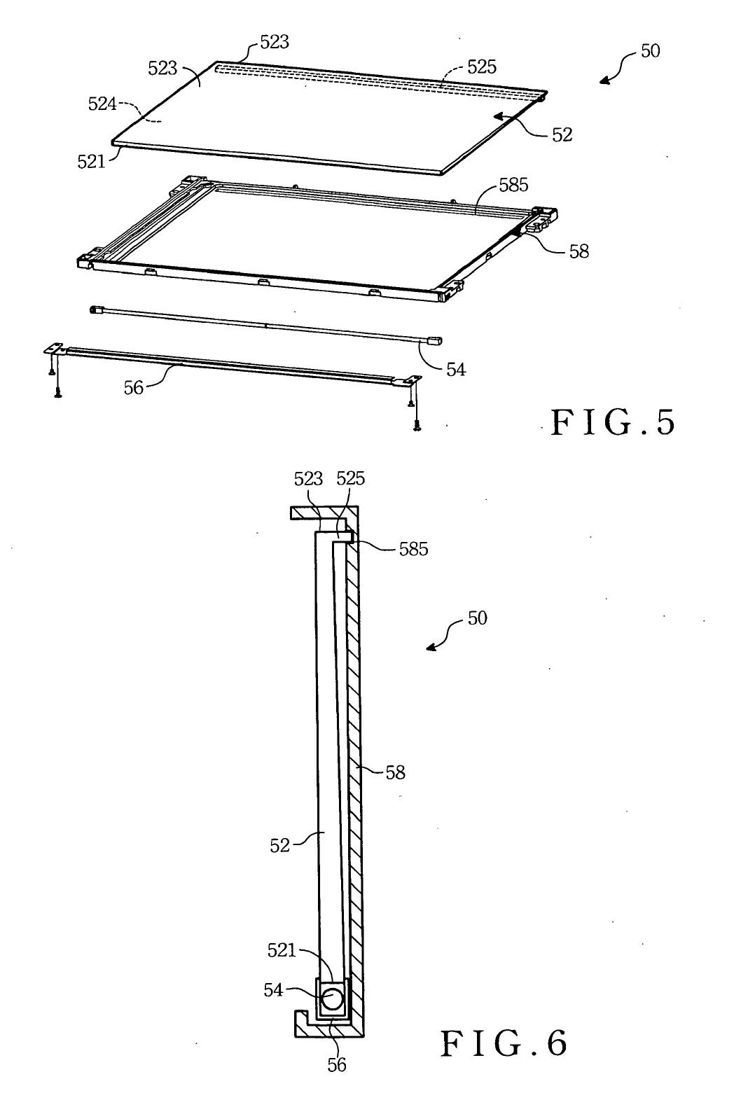

Please refer to FIG. 5 and FOG. 6. FIG. 5 is an explosion diagram of the backlight module of the present invention; FIG. 6 shows a cross-section view of the backlight module of FIG. 5. A backlight module 50 comprises a light-guide plate 52, a lamp 54, a lamp-reflector 56, and a frame 58. The light-guide plate 52 comprises a back-end 521, an upper-surface 522, a front-end 523, and a bottom-surface 524. The backlight module 50 is used in a display like LCD (liquid crystal display).

The light-guide plate 52 is disposed on the frame 58, within, the bottom-surface 524 of the light-guide plate 52 is corresponding to the frame 58. The light-guide plate 52 can be made by acrylic material that pervious to light, and it may be made by Injection Molding in practice. In one preferred embodiment, the bottom-surface 524 of the light-guide plate 52 has a protrusion pattern, which spread the light evenly. For example, a V-cut light-guide plate is used to obtain the light-spreading function described above. Besides, a plurality of optical films is disposed on the upper-surface 523 to enhance brightness or to output the light 14 evenly.

The lamp-reflector 56 disposed outside the lamp 54 has a C-shape structure for shielding and reflecting purpose. The reflectivity of the lamp-reflector 56 can converge the light generated from the lamp 54 at the back-end 521. The C-shape lamp-reflector 56 as shown can mount thereinside the lamp 54 and the back-end 521 of the light-guide plate 52 nicely and tightly.

The lamp-reflector 56 and the back-bezel 58 can be fixed by proper joining means such as a screw-and-hole pair, or an anchoring bolt-and-slot pair. With the help of the lamp-reflector 56, the light-guide plate 52 inside the back-bezel 58 can be fixed at the back-end 521.

The primary characteristic of the present invention is a fixing mechanism of the backlight module 50. The fixing mechanism comprises a rib 525 and a trough 585, so as to fix the light-guide plate 52 with the frame 58. The rib 525 is disposed on the bottom-surface 524 of the light-guide plate 524 near the front-end 523. The trough 585, corresponding to the rib 525, is disposed on the frame 58. When the light-guide plate 52 combines with the frame 58, the rib 525 is disposed in the trough 585. The rib 525 is restrained by the trough 585 so as to avoid the interactive sliding between the light-guide plate 52 and the frame 58. Thus, even during crashes, the light-guide plate may not hit on the lamp 56 easily.

FIG. 6 shows the combined situation of the light-guide plate 52 and the frame 60. The C-shape lamp-reflector 56 clamps the back-end 521 of the light-guide plate 52, and the rib 525 is restrained by the trough 585. The clamping force of the lamp-reflector 56 enables the light-guide plate 54 uneasily to depart from the frame 58. The restraining force of the trough 585 toward the rib 525 is capable of avoiding the sliding between the light-guide plate 52 and the frame 58.

Please compare FIG. 6 with FIG. 4, the advantages of the present invention can be comprehended. In Prior Art II (shown in FIG. 4), although, an adhesives 45 limits the sliding of the light-guide plate 32, the adhesive force of the adhesives 45 is not capable of sustaining the shaking or crashing force. Especially, during a series of strict impact tests before products shipping, the conventional light-guide plate 32 hits the lamp 34 and causes the damage of the lamp 34 frequently. In comparison with Prior Art II, The backlight module 50 can pass the impact test, wherein the light-guide plate 52 does not hit the lamp 54. In addition, the backlight module 50 generally stands as shown in FIG. 6 when a LCD or a display is used. The combination of the rib 525 and the trough 585 sustains the weight of the light-guide plate 52. Hence, the present invention indeed provides a solid and stable backlight module 50.

In one embodiment of the present invention, some adhesives could be used in trough 585 to further restrain the rib 525. But even the backlight module 50 is under high temperature conditions, for example, while it is operating, and causing the adhesives lose its adhesive ability. The fixing mechanism (the rib 525 and the trough 585) can still maintains good stability of the assembly.

As shown in FIG. 6, the rib 525 is disposed on the bottom-surface 524 of the light-guide plate 52 near the front-end 523, which is the same location with the adhesives 45 (FIG. 4) of Prior Art II. Hence, placing the rib 525 in this location enables the other devices of the backlight module 50 to stay in the conventional location. This avoids large changes when producing the other devices of the backlight module 50.

Please compare FIG. 5 with FIG. 2. In Prior Art I (shown in FIG. 2), a side-protrusion structure 225 may results in light leakage phenomenon and influence the display quality. The rib 525 of the present invention, disposed in the bottom-surface 524 of the light-guide plate 52, enables the upper-surface 522 remain a rectangular shape corresponding to the panel of the display. Hence, the present invention, without the light leakage phenomenon of Prior Art I, has promoted the display quality.

In some embodiments of the present invention, the rib 525 and the trough 585 shown in FIG. 5 and FIG. 6 may change into other forms or shapes. And so, the number of the rib 525 and the trough 585 is not going to be limited.

With all the embodiments and detailed descriptions of the present invention that are mentioned above, the present invention can 1) prevent light leakages on the display and 2) intensify the anti-vibration ability to enhance the overall stability of the backlight module; so that even under strong crashes or vibrations, the light-guide plate would not strike on lamp to cause any further damage inside.

While the preferred embodiment of the invention has been illustrated and described, it will be appreciated that various changes and modifications can be made therein without departing from the spirit and scope of the invention.

1. A fixing mechanism for a backlight module having a light-guide plate and a frame, wherein the light-guide plate is combined with the frame, said fixing mechanism comprising:
a rib formed on the bottom surface of the light-guide plate; and
a trough, formed on the frame, for engaging with the rib.

2. The fixing mechanism according to claim 1, wherein the rib is adjacent to one end of the light-guide plate.

3. The fixing mechanism according to claim 1, wherein the light guide plate is a V-cut light-guide plate.

4. A backlight module, comprising:
a light-guide plate having a rib formed on the bottom surface thereof;
a frame having a trough formed thereon, so that the trough engages with the rib;
a lamp disposed at one end of the light-guide plate; and
a reflector, disposed adjacent to the lamp, for fixing the one end of the light-guide plate with the frame.

5. The backlight module according to claim 4, wherein a plurality of optical films are disposed on the upper surface of the light-guide plate.

6. The backlight module according to claim 4, wherein the bottom surface of the light-guide plate has a protrusion pattern.

7. The backlight module according to claim 4, wherein the rib is formed on the bottom surface of the light-guide plate adjacent to the other end thereof.

8. The backlight module according to claim 4, wherein the light-guide plate is a V-cut light-guide plate.
